(19) United States
(12) Patent Application Publication
(10) Pub. No.: US 2015/0146078 A1
(43) Pub. Date: May 28, 2015

(54) SHIFT CAMERA FOCUS BASED ON SPEAKER POSITION

(71) Applicant: Cisco Technology, Inc., San Jose, CA (US)

(72) Inventors: Glenn AARRESTAD, Hovik (NO); Vigleik NORHEIM, Oslo (NO); Frode TJONTVEIT, Oslo (NO); Kristian TANGELAND, Oslo (NO)

(73) Assignee: Cisco Technology, Inc., San Jose, CA (US)

(21) Appl. No.: 14/092,002

(22) Filed: Nov. 27, 2013

(51) Int. Cl. H04N 5/232

(52) U.S. Cl. CPC H04N 5/23212
USPC 348/345

(57) ABSTRACT

An image-capturing device includes a receiver that receives distance and angular direction information that specifies an audio source position from a microphone array. The device also includes a controller that determines whether to change an initial focal plane within a field of view based on the audio source position. The device includes a focus adjuster that adjusts an optical focus setting to change from the initial focal plane to a subsequent focal plane within the field of view to focus on at least one object-of-interest located at the audio source position, based on a determination by the controller.

### BACKGROUND

1. Technical Field

Embodiments described herein relate generally to a method, non-transitory computer-readable storage medium, and system for audio-assisted optical focus setting adjustment in an image-capturing device. More particularly, embodiments of the present disclosure relate to a method, non-transitory computer-readable storage medium, and system for adjusting the optical focus setting of the image-capturing device to focus on a speaking person, based on audio from the speaking person.

2. Background

In a conference room or environment with multiple people in attendance, several speakers may be seated at different locations around the conference room. It is often difficult to determine where the speaker is located. Especially in situations in which captured images of the conference room are being viewed remotely, remote viewers may not have the same breadth and depth of experience attained by in-person attendees because remote viewers may be unable to ascertain which speaker is speaking.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 illustrates an exemplary diagram of an image-capturing device implementing the herein-described speaker-assisted focusing method;

FIG. 2 illustrates an exemplary diagram of the speaker-assisted focusing system;

FIG. 3 illustrates an exemplary image frame corresponding to the speaker-assisted focusing system diagram in FIG. 2;

FIG. 4 illustrates an exemplary configuration of the speaker-assisted focusing system;

FIG. 5 illustrates an exemplary image frame corresponding to the speaker-assisted focusing system diagram in FIG. 4;

FIG. 6 illustrates an exemplary configuration of the speaker-assisted focusing system;

FIG. 7 illustrates an exemplary image frame corresponding to the speaker-assisted focusing system diagram in FIG. 6;

FIG. 8 illustrates an exemplary process flow diagram of the speaker-assisted focusing method;

FIG. 9 illustrates an exemplary process flow diagram of the speaker-assisted focusing method; and

FIG. 10 illustrates an exemplary computer.

### DETAILED DESCRIPTION OF EXAMPLE EMBODIMENTS

Overview

According to one aspect of the present disclosure, an image-capturing device includes a receiver that receives distance and angular direction information that specifies an audio source position from a microphone array. The image-capturing device also includes a controller that determines whether to change an initial focal plane to a subsequent focal plane within a field of view of an image frame based on a detected change in the audio source position. The image-capturing device further includes a focus adjuster that adjusts an optical focus setting to change from the initial focal plane to the subsequent focal plane within the field of view to focus on at least one object-of-interest located at the audio source position, based on a position determination by the controller.

While this invention is susceptible of embodiment in many different forms, there is shown in the drawings and will herein be described in detail specific examples of the principles and not intended to limit the invention to the specific examples shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “program” or “computer program” or similar terms, as used herein, is defined as a sequence of instructions designed for execution on circuitry of a computer system, whether in a single chassis or distributed amongst several devices. A “program”, or “computer program”, may include a subroutine, a program module, a script, a function, a procedure, an object method, an object implementation, in an executable application, an applet, a servlet, a source code, an object code, a shared library/dynamic load library and/or other sequence of instructions designed for execution on a computer system.

Reference throughout this document to “one embodiment”, “certain embodiments”, “an embodiment”, “an implementation”, “an example” or similar terms means that a particular feature, structure, or characteristic described in connection with the example is included in at least one example of the present disclosure. Thus, the appearances of such phrases or in various places throughout this specification are not necessarily all referring to the same example. Furthermore, the particular features, structures, or characteristics may be combined in any suitable manner in one or more examples without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Due to camera limitations, all participants at one endpoint may be visible within an image frame, but they may not be able to fit within a region-of-interest specified by a current optical focus setting of an image capturing device. For example, one participant may be located in a first focal plane of the camera, but another participant might be located in a different image plane. To overcome this limitation, audio data sourced by a relevant target, e.g., a current speaker, is obtained and used to change the optical focus setting of the image capturing device to a new optical focus setting that focuses on the relevant target. Thus, a viewer at another endpoint would see a focused image of the person speaking at the first endpoint, and then later a focused image of a second person at the first endpoint when that second person is the primary speaker.

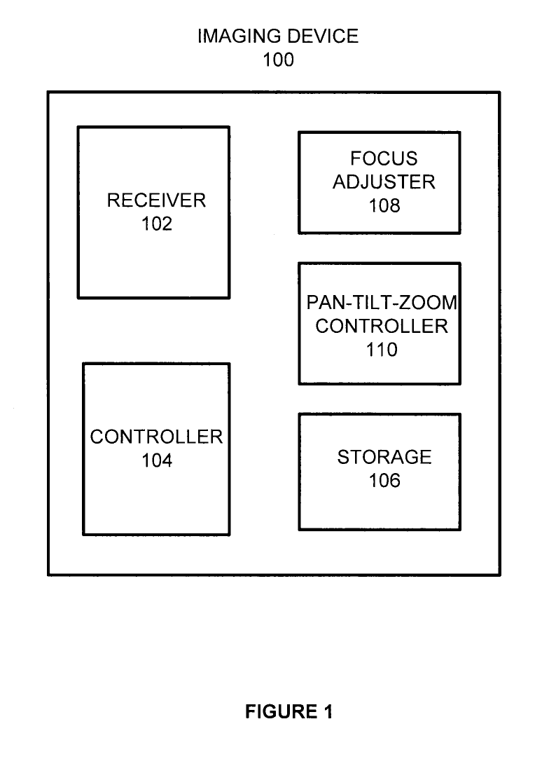

FIG. 1 illustrates a diagram of an exemplary image-capturing device implementing the herein-described speaker-assisted focusing method. The image-capturing device 100 includes a receiver 102 that receives distance and angular direction information that specifies a location of a source of audio picked up by a microphone array. The audio source is, for example, a person that is speaking, i.e., a current speaker. The image-capturing device 100 also includes a controller 104 that, among other things, determines whether to adjust a pan-tilt-zoom setting of the image-capturing device and controls the adjustment of this setting. The controller 104 also determines whether to adjust an optical focus setting of the image-capturing device and controls the adjustment of this setting. The controller 104 makes these determinations and controls these adjustments based on the location of the audio source and optionally, based on determinations made with respect to the audio source itself. The controller 104 optionally makes use of either or both facial detection processing and stored mappings to determine whether to adjust the pan-tilt-zoom setting or the optical focus setting of the image-capturing device 100. It is noted that the facial detection processing need not necessarily detect a full frontal facial image. For example, silhouettes, partial faces, upper bodies, and gaits are detectable with detection processing.

The above-described mappings are stored in storage 106 in the image-capturing device 100. These mappings specify a correspondence between the location, which is specified with respect to a room layout, and at a minimum, an indication of whether a face was previously detected at the location. The mappings are not limited to only specifying a correspondence with the indication; for example, an image of the detected face is storable in addition to or in place of the indication.

In one non-limiting example, the controller 104 determines that the pan-tilt-zoom setting must be changed and controls a pan-tilt-zoom controller 110 in the image-capturing device 100 to adjust this setting. The pan-tilt-zoom controller 110 changes the pan-tilt-zoom setting so as to include the audio source, e.g., the person, which is the source of the audio picked up by the microphone array, in a field of view (or image frame) of the image-capturing device. The controller 104 also determines that the optical focus setting must be changed and controls a focus adjuster 108 in the image-capturing device 100 to adjust this setting. The focus adjuster 108 adjusts the optical focus setting in order to focus on the audio source, e.g., the person, which is the source of the audio picked up by the microphone array.

It should be noted that an image-capturing device implementing the speaker-assisted focusing method is not limited to the configuration shown in FIG. 1. For example, it is not necessary for each of the receiver 102, the controller 104, and the storage 106 to be implemented in the image-capturing device 100. The storage 106 and the controller 104 are alternatively or additionally implementable external to the image-capturing device 100.

The image-capturing device 100 is implementable by one or more of the following including, but not limited to: a video camera, a cell phone, a digital still camera, a desktop computer, a laptop, and a touch screen device. The receiver 102, the controller 104, the focus adjuster 108, and the pan-tilt-zoom controller 110 are controlled or implementable by one or more of the following including, but not limited to: circuitry, a computer, and a programmable processor. Other examples of hardware and hardware/software combinations upon which these elements are implemented and by which these elements are controlled are described below. The storage 106 is implementable by, for example, a Random Access Memory (RAM). Other examples of storage are described below.

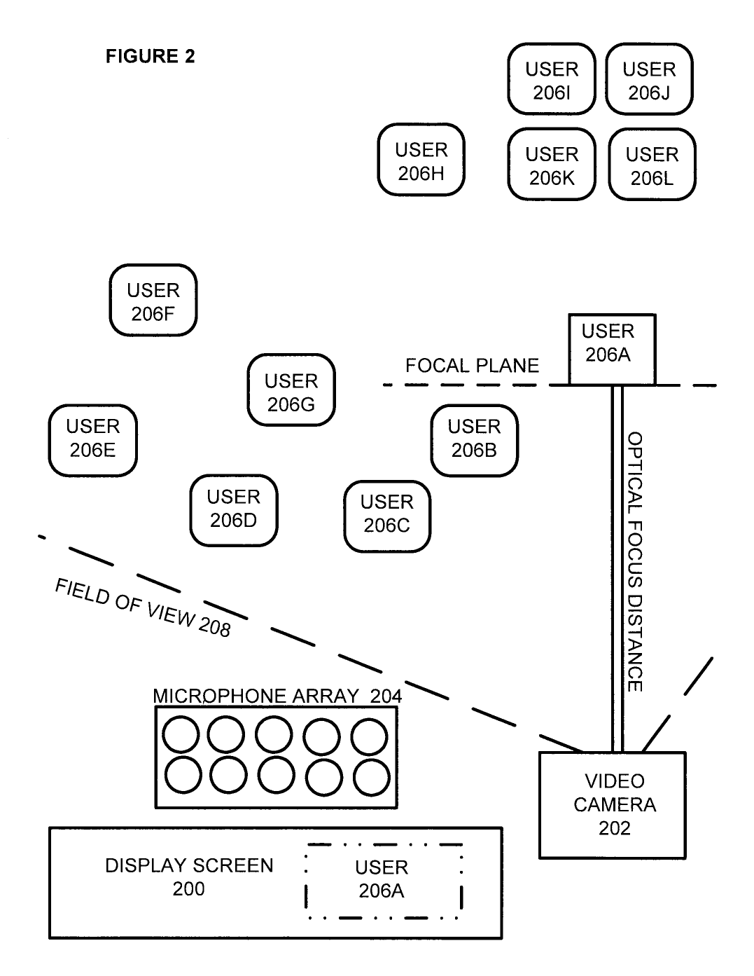

FIG. 2 illustrates an exemplary diagram of the herein-described speaker-assisted focusing system. More particularly, FIG. 2 shows a display screen 200, a video camera 202, and a microphone array 204. The microphone array 204 includes a variable number of microphones that depends on the size and acoustics of a room or area in which the speaker-assisted focusing system is deployed. In one non-limiting example, indications provided by the microphone array 204 are supplemented by or conditioned with data from a depth sensor or a motion sensor. When one of the users 206a, 206b, 206c, 206d, 206e, 206f, 206g, 206h, 206i, 206j, 206k, and 206l starts talking, the microphone array 204 captures the distance and angular direction to the user that is speaking and provides this information, via a wired or wireless link, to the video camera 202.

The video camera 202 uses this information to change its optical focus setting by a focus adjuster based on, for example, adjusting an optical focus distance. Objects in a focal plane corresponding to an adjusted optical focus distance are “in focus” or “focused on.” These objects are objects-of-interest. The field of view 208 includes everything visible to the video camera 202 (i.e., everything “seen” by the one or more video camera 202). In FIG. 2, the field of view 208 includes all of the users 206a, 206b, 206c, 206d, 206e, 206f, 206g, 206h, 206i, 206j, 206k, and 206l; thus, it is not necessary to change the field of view 208. In a non-limiting example, the field of view 208 is changed by a pan-tilt-zoom controller in the video camera 202, so as to, perhaps, capture an otherwise unseen user in the field of view 208.

In the exemplary configuration shown in FIG. 2, user 206a starts to talk and the video camera 202, upon detection of user 206a speaking, adjusts its optical focus setting so as to focus on user 206a. User 206a is in the focal plane corresponding to the adjusted focus distance. In this manner, user 206a becomes the object-of-interest, as shown in FIG. 2. The rest of users 206b, 206c, 206d, 206e, 206f, 206g, 206h, 206i, 206j, 206k, and 206l that are not talking are not focused on and are represented as non-speaking users by shapes having rounded corners in FIG. 2. Also shown in FIG. 2 is the display screen 200, which displays an image or video of the object-of-interest, user 206a, that is currently speaking. This facilitates the other users 206b, 206c, 206d, 206e, 206f, 206g, 206h, 206i, 206j, 206k, and 206l in ascertaining the speaker's identity and the content of the speaker's speech.

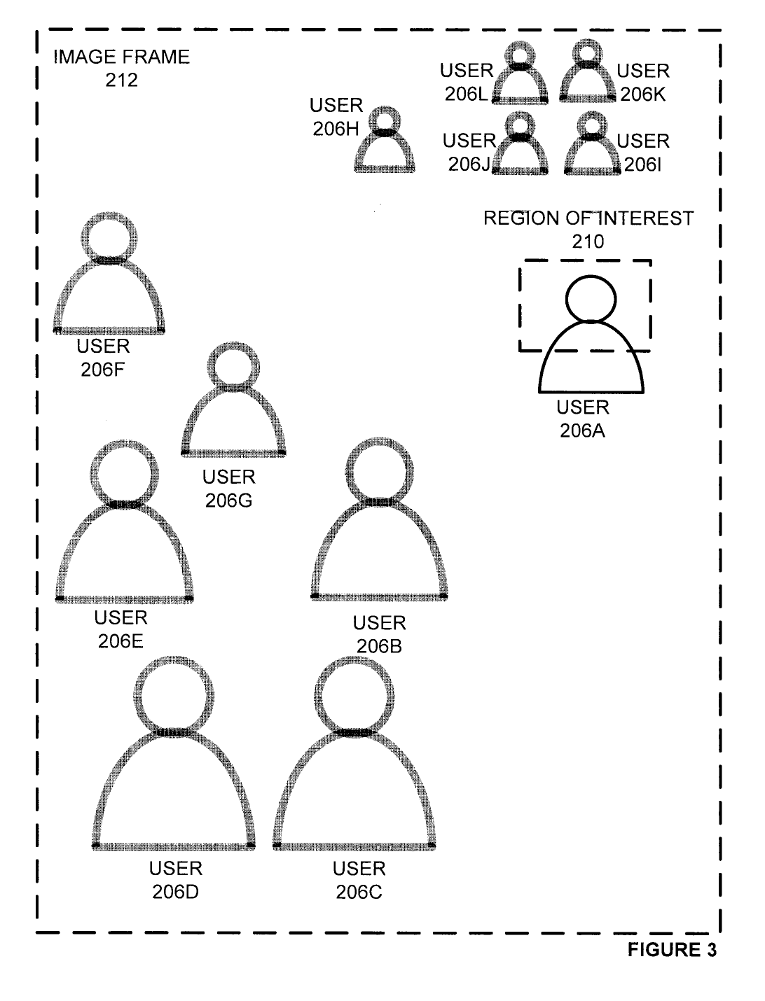

FIG. 3 illustrates an exemplary image frame 212 (corresponding to the field of view 208 in FIG. 2) that is displayed by the video camera 202, in which users 206a, 206b, 206c, 206d, 206e, 206f, 206g, 206h, 206i, 206j, 206k, and 206l are viewable. User 206a is the object-of-interest, which is focused on, and is represented with a black dashed outline in FIG. 3. Users 206b, 206c, 206d, 206e, 206f, 206g, 206h, 206i, 206j, 206k, and 206l are not focused on and are represented as non-speaking users with a blurred outline. As a side note, any of the other users may also be in the same focal plane as user 206a and thus may also be in focus, unless an optional burring filter is used to blur images outside of a region-of-interest. In the example of FIG. 3, the image frame 212 is displayed on a viewfinder of the video camera 202 and, in one non-limiting embodiment, is annotated with a region-of-interest 210. The region-of-interest 210, which corresponds to a portion of the field of view 208, is determined by a controller in the video camera 202 and includes at least a portion of the object-of-interest. The controller displays the region-of-interest 210 in the image frame 212 as a box around the portion of the object-of-interest, i.e., around the head of user 206a.

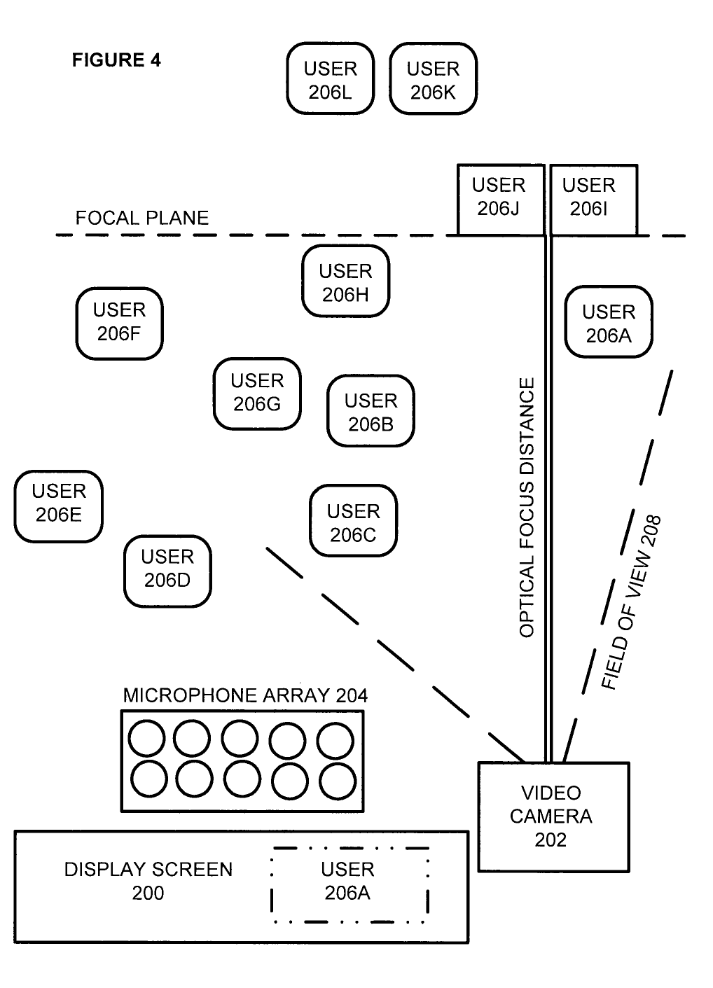

In FIG. 4, another exemplary configuration of the speaker-assisted focusing system is shown. This example differs from that shown in FIG. 2 insofar as the field of view 208 does not include all of the users 206a, 206b, 206c, 206d, 206e, 206f, 206g, 206h, 206i, 206j, 206k, and 206l. FIG. 4 shows how users 206d and 206e are outside of the field of view 208 of the video camera 202. When one of users 206i and 206j begin to speak, the optical focus setting of the video camera 202 is adjusted so that users 206i and 206j are focused on and user 206a is no longer focused on.

Instead of only one object-of-interest, FIG. 4 illustrates two objects-of-interest as being focused on; this is because both of users 206i and 206j are proximate to each other in the focal plane corresponding to the adjusted optical focus distance. Multiple objects-of-interest may exist, for example, when one of the users 206i starts speaking and is too close to another user, e.g., 206j, to only focus on the user 206i that is speaking. As another example, when users 206i and 206j are speaking simultaneously, the video camera 202 may focus on multiple objects-of-interest. As yet another example, when users 206i and 206j take turns speaking, but speak in rapid succession, the video camera 202 may focus on multiple objects-of-interest to avoid changing the object-of-interest too rapidly. Furthering this example, the video camera focuses on multiple objects-of-interest when more than one change in speakers occurs in less than a predetermined time period, for example, ten seconds. Changing the object-of-interest too often could be disruptive to viewers and could cause “motion sickness.”

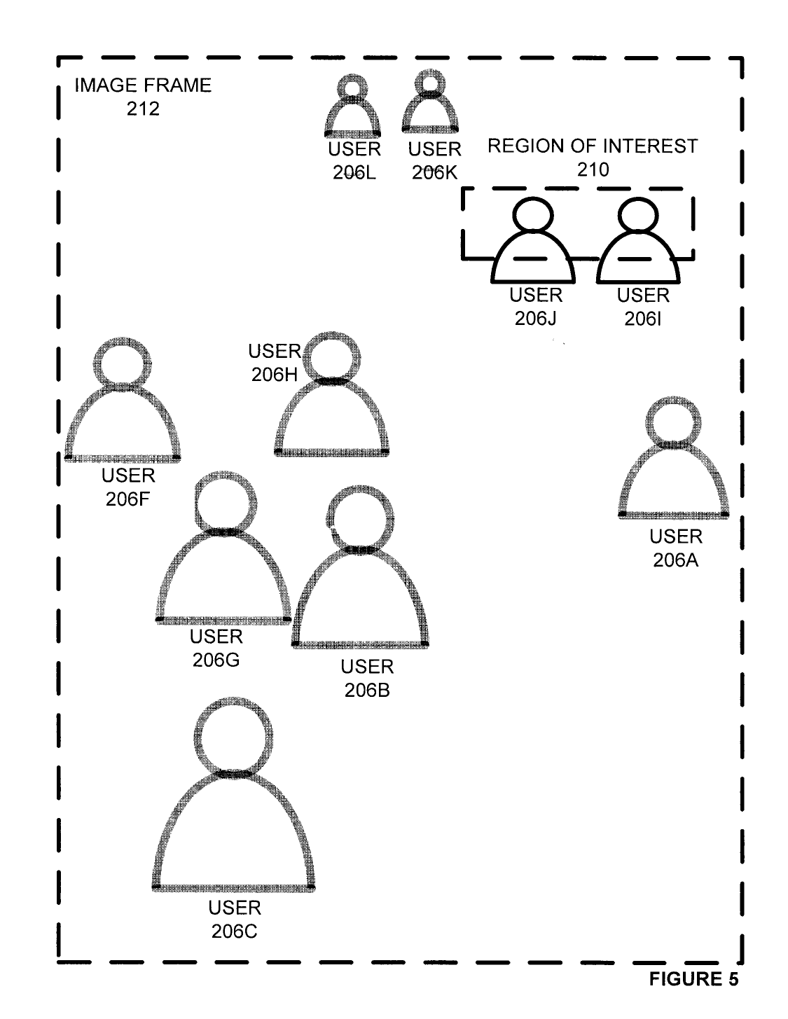

FIG. 5 illustrates an exemplary image frame 212 (corresponding to FIG. 4) displayed by the video camera 202, in which users 206a, 206b, 206c, 206f, 206g, 206h, 206i, 206j, 206k, and 206l are viewable. Users 206i and 206j are objects-of-interest and are focused on; these objects-of-interest are represented with a black outline. Users 206b, 206c, 206f, 206g, 206h, 206k, and 206l are not focused on and are represented with a blurred outline. As discussed above, the region-of-interest 210, which corresponds to a portion of the field of view 208, is determined by the controller in the video camera 202 and includes at least a portion of the objects-of-interest. The controller displays the region-of-interest 210 in the image frame 212, which is displayed on the viewfinder of the video camera 202, as a box around the portions of the objects-of-interest, i.e., around the heads of user 206i and user 206j.

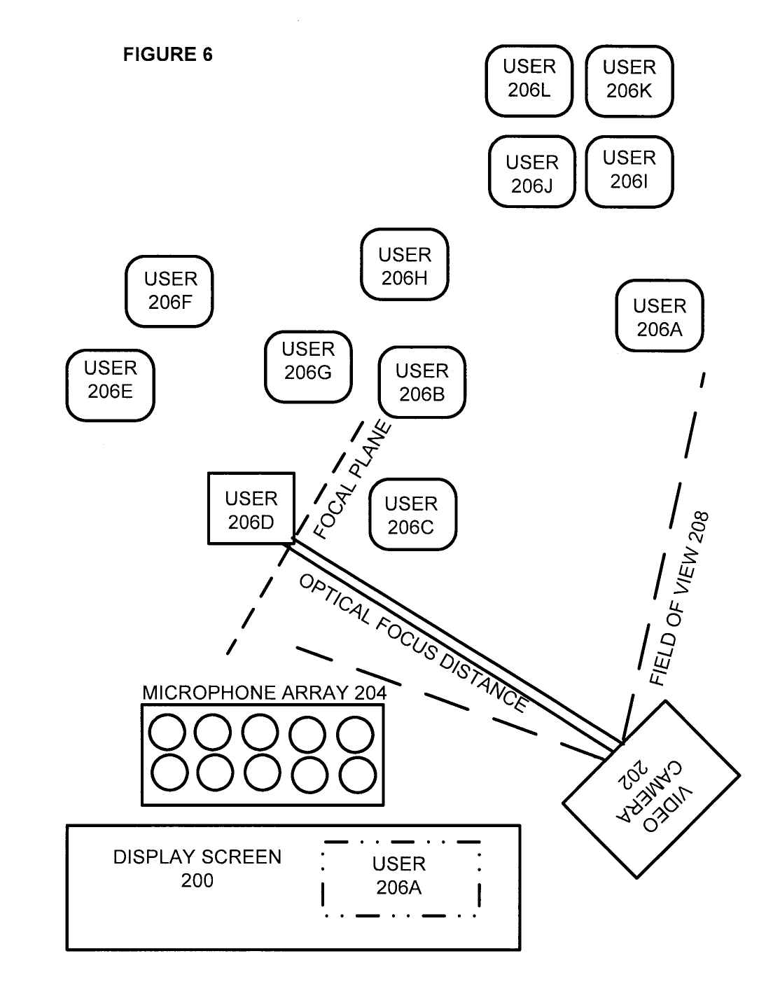

In FIG. 6, another exemplary configuration of the speaker-assisted focusing system is shown. When user 206d starts speaking, the video camera 202 must change the field of view 208 from that shown in FIG. 4 to that which is shown in FIG. 6, prior to adjusting the optical focus setting to focus on the user 206d. Since users 206i and 206j are no longer the objects-of-interest, they are represented as non-speaking users with rounded corners. The video camera 202 subsequently adjusts its optical focus setting to focus on user 206d, which is the object-of-interest. User 206d is in the focal plane corresponding to the adjusted focus distance.

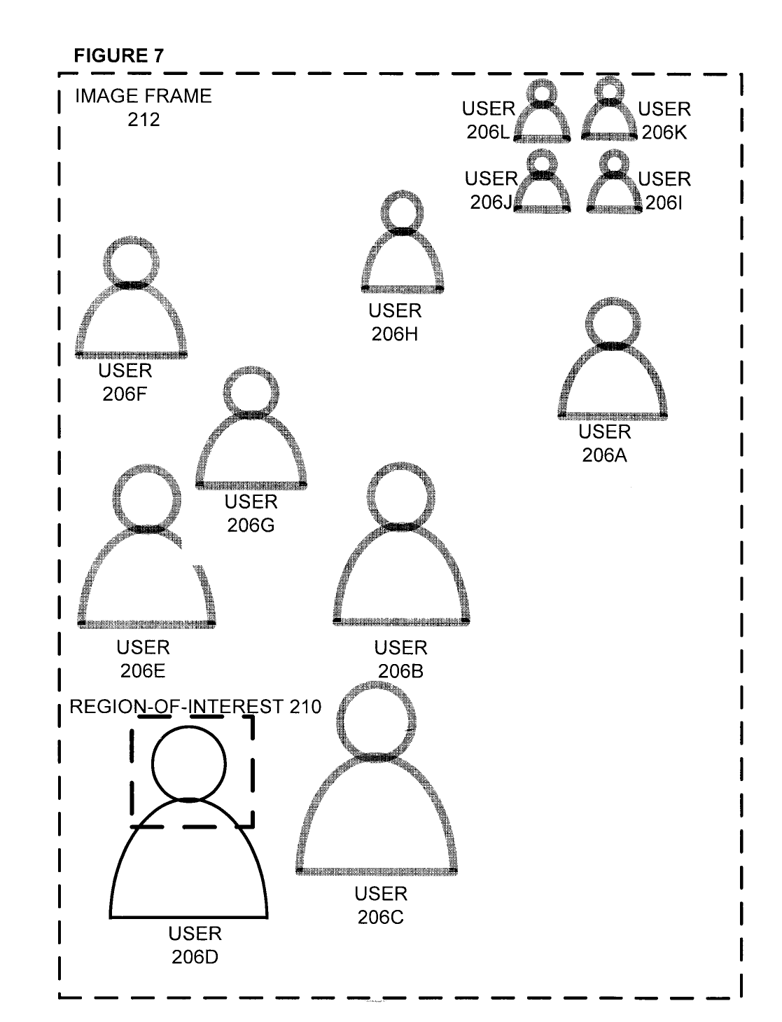

FIG. 7 illustrates an exemplary image frame 212 (corresponding to FIG. 6) displayed by the video camera 202, in which users 206a, 206b, 206c, 206d, 206e, 206f, 206g, 206h, 206i, 206j, 206k, and 206l are viewable. User 206d is the object-of-interest is focused on and represented with a black outline. Users 206a, 206b, 206c, 206e, 206f, 206g, 206h, 206i, 206j, 206k, and 206l are not focused on and represented as non-speaking users with a blurred outline. As discussed above, the region-of-interest 210, which corresponds to a portion of the field of view 208, is determined by the controller in the video camera 202 and includes at least a portion of the object-of-interest. The controller displays the region-of-interest 210 in the image frame 212, which is displayed on the viewfinder of the video camera 202, as a box around the portion of the object-of-interest, i.e., around the head of user 206d.

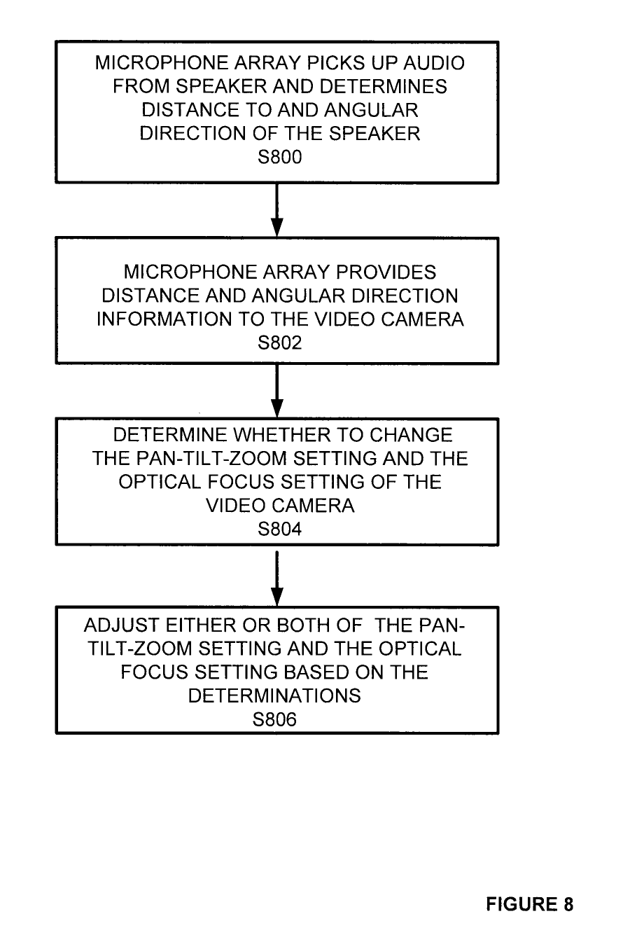

In FIG. 8, an exemplary process flow diagram of the speaker-assisted focusing method is shown. In step S800, a speaker begins to speak, and the microphone array picks up audio from the speaker's speech and determines the distance to and angular direction of the speaker. In step S802, the distance and angular direction information is provided, from the microphone array, to the video camera. A controller in the video camera makes a determination as to whether to change the pan-tilt-zoom setting and as to whether to change the optical focus setting, in step S804. The pan-tilt-zoom controller in the video camera changes the pan-tilt-zoom setting and the focus adjuster changes the optical focus setting in step S806, based on the determinations made in step S804. When the object-of-interest is within the field of view, the pan-tilt-zoom setting is not normally changed, and the focal plane is changed to correspond with the user who is speaking at that time.

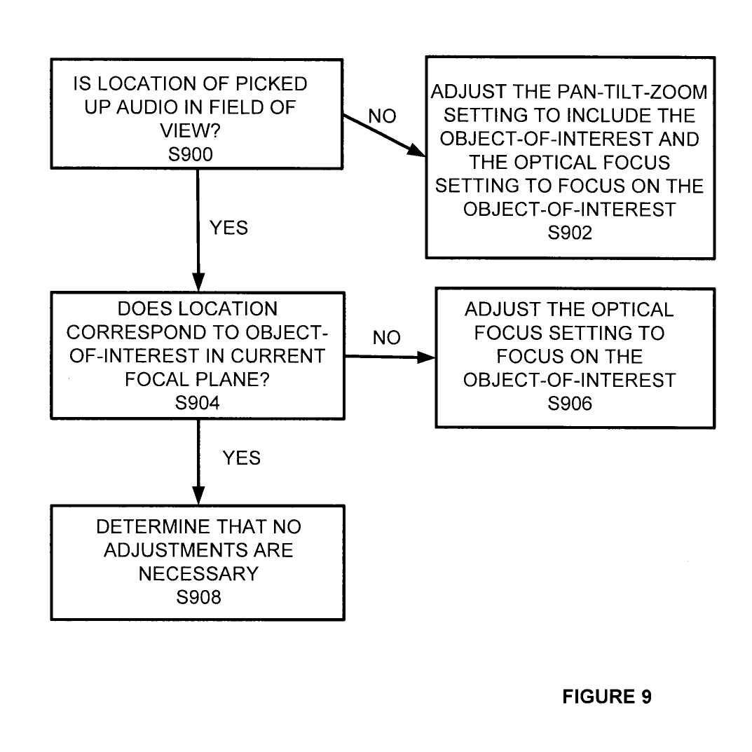

In FIG. 9, an exemplary process flow diagram of the determination process described in step S804 of FIG. 8 is shown. Initially, in step S900, a determination is made as to whether a location in a room layout, corresponding to the distance to and angular direction of the speaker, for example, user 206d shown in FIG. 4, as indicated by the microphone array, is within the field of view of the video camera. In step S902, if the location is not in the field of view, then the video camera adjusts the pan-tilt-zoom setting using the pan-tilt-zoom controller and subsequently, adjusts the optical focus setting, using the focus adjuster, to focus on the object-of-interest, e.g., user 206d, as illustrated in FIG. 6. This step is depicted by the change in the field of view 208 between FIG. 4 and FIG. 6. If the location is in the field of view 208, e.g., user 206i as illustrated in FIG. 2, then the video camera does not need to change the field of view 208. Subsequently, in step S904, a determination is made as to whether the location corresponds to an object-of-interest in a current focal plane corresponding to a current optical focus distance. In step S906, if the location is in the field of view, and the location does not correspond to the object-of-interest in the current focal plane, e.g., user 206a as illustrated in FIG. 2, then only the optical focus setting is adjusted, using the focus adjuster, to include the object-of-interest, user 206i (and user 206j) as illustrated in FIG. 4. This step is depicted in the change of the focal plane and corresponding optical focus distance between FIG. 2 and FIG. 4. If the location is in the field of view and corresponds to an object-of-interest in the current focal plane, a determination is made that no adjustments are necessary in step S908.

Face Detection

In one non-limiting example, additional determinations are made prior to changing the field of view or the region-of-interest to include the object-of-interest. In some instances, the speaker's voice may reflect off of surfaces in the room in which the video camera and microphone array are situated. To confirm that the picked up audio corresponds to a speaker and not a reflection of the voice, a face detection process is performed. In addition to the field of view and region-of-interest and object-of-interest determinations made above, a determination is made as to whether a face is detected at the location indicated by the microphone array. Detecting a face at the location confirms the existence of a speaker, instead of an audio reflection, and increases the accuracy of the speaker-assisted focusing system and method. As described above, facial detection is an exemplary detection methodology that is supplementable or replaceable with a detection process that detects a desired audio source, e.g., a person, using, for example, silhouettes, partial faces, upper bodies, and gaits.

Storing Speaker Location and Face Detection Mappings

In another non-limiting example, the video camera, or other external storage, is enabled to store a predetermined number of mappings between locations in the room layout, obtained based on information from the microphone array, i.e., speaker positions, and indications of detected faces. For example, when a speaker begins speaking and turns their head such that their face is not detectable, the video camera uses the mappings to “remember” that the microphone array previously indicated the location as a speaker position and a face was previously detected at that location. Irrespective of the fact that a face cannot currently be detected, a speaker is determined to be likely to be at that location, instead of, for example, an audio reflection.

Facial and Speech Recognition

In another non-limiting example, subsequent to or in place of performing facial detection, the video camera or external device performs facial recognition. Captured or detected faces are compared with pre-stored facial images stored in a database accessible by the video camera. In still another non-limiting example, the picked up audio is used to perform speech recognition using pre-stored speech sequences stored in the database accessible by the video camera. These exemplary and additional levels of processing provide enhanced accuracy to the speaker-assisted focusing method. In yet another non-limiting example, identity information corresponding to the recognized face is displayed on the display screen, either along with or in place of the object-of-interest. For example, a corporate or government-issued identification photograph could be displayed on the display screen.

Profile Information

In one non-limiting example, the portion of the database searched by the video camera to find a matching face or speech sequence is constrained by conference attendees that are registered for a predetermined combination of date, time, and room location. Constraining the database reduces the processing resources required to recognize faces or speech.

Gesture Detection

In one non-limiting embodiment, the region-of-interest is set so as to include a speaker that is currently speaking and is subsequently changed based on detecting gestures of the speaker. As a non-limiting example, the initial region-of-interest may focus on the speaker's face, and the subsequent region-of-interest may focus on a whiteboard upon which the speaker is writing; changing the region-of-interest to include the text written on the whiteboard could be triggered by any of the following, but not limited to: an arm motion, a hand motion, a mark made by a marker, and movement of an identifying tag (e.g., a radio frequency identifier tag) attached to the marker. As another non-limiting example, the speaker may be a lecturer using a laser pointer to designated certain areas on an overhead projector; changing the region-of-interest to include the area designated by the laser pointer could be triggered by any of the following, but not limited to: detection of a frequency associated with the laser pointer and detection of a color associated with the laser pointer.

Blurring Filter

In one non-limiting embodiment, one or more objects excluding the objects-of-interest, are shown as being out of focus or “blurred” using, for example, a blurring filter. For example, two speakers that are engaged in a conversation may be shown in focus, while remaining attendees are blurred to prevent distraction. In another non-limiting embodiment, the portion of the object-of-interest that corresponds to, for example, the user's body below the head, which is not in the region-of-interest, is not blurred.

Application Environments

While the above-described examples have been set forth with respect to focusing on speakers in an indoor room, tracking other objects-of-interest, for example, vehicles, sports players, and animals, each of which produce audio, is envisioned. Further, the present invention is not limited to being implemented indoors; the strength and accuracy of the microphone array, and optionally, attendant sensors, lend the present invention to be implementable in a variety of applications, including outdoor applications.

In a non-limiting example, the users 206a, 206b, 206c, 206d, 206e, 206f, 206g, 206h, 206i, 206j, 206k, and 206l are conference speakers or attendees that take turns speaking. In another non-limiting example, the users 206a, 206b, 206c, 206d, 206e, 206f, 206g, 206h, 206i, 206j, 206k, and 206l are distance learning students participating and asking questions to a remotely located professor. In yet another non-limiting example, the users 206a, 206b, 206c, 206d, 206e, 206f, 206g, 206h, 206i, 206j, 206k, and 206l are talk show guests that ask questions to interviewees. In still another non-limiting example, the users 206a, 206b, 206c, 206d, 206e, 206f, 206g, 206h, 206i, 206j, 206k, and 206l are actors in a television show, e.g., a reality show.

Adjusting Frame Margins

In a non-limiting embodiment, image frame margins are dynamically adjusted based on a speaker position so as to frame the speaker, within the image frame, in a specified manner. The frame margins are adjusted to communicate the speaker's location within a room and to whom the speaker is speaking by shifting the speaker left or right in the image frame by a specified amount, which depends on a distance between the speaker and a predefined central axis.

In another non-limiting embodiment, the image frame margins are dynamically adjusted based on the direction that the speaker faces. The orientation of the speaker's head affects the horizontal framing of the speaker in the image frame; if a speaker looks away from the predefined central axis, then speaker is centered in the image frame and the frame margins are adjusted to include more space in front of the speaker's face.

In one non-limiting embodiment, the frame margins are automatically adjusted according to cinematic composition rules; this advantageously reduces the cognitive load on the viewers, more closely conforms to viewers' expectations on television and film productions, and improves the overall quality of experience. In a non-limiting example, composition rules may capture context associated with a whiteboard when a speaker addresses a video camera, while still tracking the speaker.

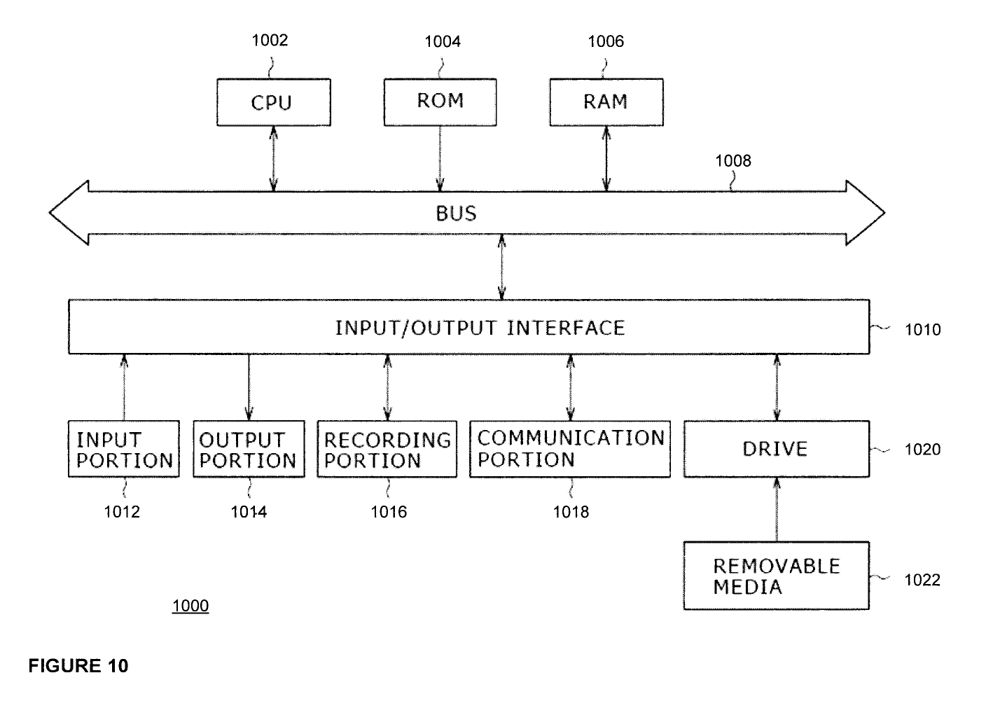

FIG. 10 is a block diagram showing an example of a hardware configuration of a computer 1000 that can be configured to perform one or a combination of the functions of the video camera 202 and the microphone array 204, such as the determination processing.

As illustrated in FIG. 10, the computer 1000 includes a central processing unit (CPU) 1002, read only memory (ROM) 1004, and a random access memory (RAM) 1006 interconnected to each other via one or more buses 1008. The one or more buses 1008 are further connected with an input-output interface 1010. The input-output interface 1010 is connected with an input portion 1012 formed by a keyboard, a mouse, a microphone, remote controller, etc. The input-output interface 1010 is also connected to an output portion 1014 formed by an audio interface, video interface, display, speaker, etc.; a recording portion 1016 formed by a hard disk, a non-volatile memory or other non-transitory computer-readable storage medium; a communication portion 1018 formed by a network interface, modem, USB interface, fire wire interface, etc.; and a drive 1020 for driving removable media 1022 such as a magnetic disk, an optical disk, a magneto-optical disk, a semiconductor memory, etc.

According to one example, the CPU 1002 loads a program stored in the recording portion 1016 into the RAM 1006 via the input-output interface 1010 and the bus 1008, and then executes a program configured to provide the functionality of the one or combination of the functions of the video camera 202 and the microphone array 204, such as the determination processing.

Those skilled in the art will recognize, upon consideration of the above teachings, that certain of the above examples, for example using the video camera 202 and the microphone array 204, are based upon use of a programmed processor. However, examples of the present disclosure are not limited to such examples, since other examples could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent examples.

Those skilled in the art will appreciate, upon consideration of the above teachings, that the operations and processes, such as those by the video camera 202 and the microphone array 204, and associated data used to implement certain of the examples described above can be implemented using disc storage as well as other forms of storage such as non-transitory storage devices including as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain examples of the present disclosure. The term non-transitory does not suggest that information cannot be lost by virtue of removal of power or other actions. Such alternative storage devices should be considered equivalents.

Certain examples described herein, are or may be implemented using one or more programmed processors executing programming instructions that are broadly described above in flow chart form that can be stored on any suitable electronic or computer readable storage medium. However, those skilled in the art will appreciate, upon consideration of the present disclosure, that the processes described above can be implemented in any number of variations and in many suitable programming languages without departing from examples of the present disclosure. For example, the order of certain operations carried out can often be varied, additional operations can be added or operations can be deleted without departing from certain examples of the disclosure. Such variations are contemplated and considered equivalent.

While certain illustrative examples have been described, it is evident that many alternatives, modifications, permutations and variations will become apparent to those skilled in the art in light of the foregoing description.

1. An image-capturing device comprising:
a receiver that receives distance and angular direction information that specifies an audio source position from a microphone array;
a controller, including processing circuitry, that determines whether to change an initial focal plane within a field of view based on the audio source position; and
a focus adjuster, including focus adjusting circuitry, that adjusts an optical focus setting to change from the initial focal plane to a subsequent focal plane within the field of view to focus on at least one object-of-interest located at the audio source position, based on a determination made by the controller.

2. The image-capturing device according to claim 1, further comprising:
a storage that stores a mapping of the audio source position and image data corresponding to the at least one object-of-interest.

3. The image-capturing device according to claim 2, wherein the storage stores a predetermined number of mappings based on at least one of a number of objects-of-interest, including the at least one object-of-interest, in a room in which the image-capturing device is located and a size of the room.

4. The image-capturing device according to claim 1, further comprising:
a blurring filter that blurs objects in the field of view that are not in the subsequent focal plane or not included in the at least one object-of-interest.

5. The image-capturing device according to claim 1, wherein the controller determines a region-of-interest related to the subsequent focal plane that includes the at least one object-of-interest.

6. The image-capturing device according to claim 5, wherein the region-of-interest includes only one object-of-interest that corresponds to a person who is determined to be associated with the audio source position.

7. The image-capturing device according to claim 5, wherein the region-of-interest includes only a portion of the at least one object-of-interest.

8. The image-capturing device according to claim 1, wherein the image-capturing device is one of: a video camera, a cell phone, a digital still camera, a desktop computer, a laptop, and a touch screen device.

9. The image-capturing device according to claim 1, wherein the focus adjuster adjusts the optical focus setting, in real-time, while capturing image data.

10. A method for controlling an image-capturing device, comprising:
receiving distance and angular direction information that specifies an audio source position from a microphone array;
determining, by processing circuitry in the image-capturing device, whether to change an initial focal plane within a field of view based on the audio source position; and
adjusting, by focus adjusting circuitry in the image-capturing device, an optical focus setting to change from the initial focal plane to a subsequent focal plane within the field of view to focus on at least one object-of-interest located at the audio source position, based on the determining.

11. The method according to claim 10, further comprising: detecting a face at the audio source position.

12. The method according to claim 10, further comprising: recognizing a face at the audio source position.

13. The method according to claim 10, further comprising:
recognizing an identity of a person corresponding to the audio source position based on speech recognition.

14. The method according to claim 13, further comprising:
displaying information corresponding to the identity of the person on a display, separate from a display of the image-capturing device.

15. The method according to claim 10, further comprising:
detecting a user gesture proximate to the audio source position; and
adjusting, by the focus adjusting circuitry, the optical focus setting to focus on an area corresponding to a location at which the user gesture was detected.

16. The method according to claim 10, wherein objects excluding the at least one object-of-interest that are in the field of view and outside the subsequent focal plane are not in focus.

17. The method according to claim 10, further comprising:
determining, by the processing circuitry, a region-of-interest related to the subsequent focal plane that includes the at least one object-of-interest, and
displaying the region-of-interest on an image frame displayed by the image-capturing device.

18. The method according to claim 10, further comprising:
adjusting, by the focus adjusting circuitry, the optical focus to focus on another focal plane that includes a plurality of objects-of-interest, when a plurality of audio source positions within a predetermined distance of each other are identified, the plurality of audio source positions including the audio source position.

19. The method according to claim 10, further comprising:
adjusting, by the focus adjusting circuitry, the optical focus to focus on another plane that includes a plurality of objects-of-interest, when the audio source position changes before a predetermined time period has elapsed.

20. Logic encoded on one or more tangible media for execution and when executed operable to:
receive distance and angular direction information that specifies an audio source position from a microphone array;
determine, using circuitry, whether to change an initial focal plane within a field of view based on the audio source position; and
adjust an optical focus setting to change from the initial focal plane to a subsequent focal plane within the field of view to focus on at least one object-of-interest located at the audio source position, based on the determining.
